(19) United States
(12) Patent Application Publication
(10) Pub. No.: US 2018/0007307 A1
(43) Pub. Date: Jan. 4, 2018

(54) Distributed Implementation Architecture for Broadcast Receiver

(71) Applicant: QUALCOMM Incorporated, San Diego, CA (US)

(72) Inventors: Gordon Kent Walker, Poway, CA (US); Giridhar Mandyam, San Diego, CA (US); Charles Nung Lo, San Diego, CA (US); Peter William Resnick, Urbana, IL (US); Thomas Stockhammer, Bergen (DE)

(21) Appl. No.: 15/607,934

(22) Filed: May 30, 2017

Related U.S. Application Data
(60) Provisional application No. 62/357,949, filed on Jul. 2, 2016.
(60) Provisional application No. 62/399,592, filed on Sep. 26, 2016.

(51) Int. Cl. H04N 5/44; H04N 5/60; H04N 5/46; H04N 21/414; H04H 60/19

(52) U.S. Cl. CPC H04N 5/4401; H04N 21/41407; H04H 60/19; H04N 5/46; H04N 5/602

(57) ABSTRACT

Systems, methods, and devices of various embodiments enable a distributed broadcast receiver implementation. In various embodiments, a gateway may redistribute broadcast content to one or more personal devices over a local network. In some embodiments, system time information may be obtained by the personal devices and a local replica of system time information may be maintained within a light server executing within the personal device and functioning as a local synch server. In some embodiments, system time information may be obtained by the gateway and a local replica of system time information may be maintained within a light server executing within the gateway and functioning as a local synch server.

### RELATED APPLICATIONS

This application claims the benefit of priority to U.S. Provisional Patent Application No. 62/357,949 entitled “Distributed Implementation Architecture for Broadcast Receiver” filed Jul. 2, 2016 and to U.S. Provisional Patent Application No. 62/399,592 entitled “Distributed Implementation Architecture for Broadcast Receiver” filed Sep. 26, 2016. The entire contents of both provisional applications are hereby incorporated by reference.

### BACKGROUND

In current gateway and personal device systems, the partition of functionalities between the gateway and the personal device may present security implementation issues. These problems may become particularly acute in systems in which a gateway is used for redistribution of broadcast content, such as content downloaded according to the Advanced Television Systems Committee (ATSC) standards (e.g., ATSC 2.0, ATSC 3.0, etc.), evolved Multimedia Broadcast Multicast Service (eMBMS) standards, Digital Video Broadcasting (DVB) standards, etc. For example, restrictions regarding broadcast content (e.g., access control, etc.) can carryover from a broadcaster to personal device when content is redistributed via a gateway in current systems.

### SUMMARY

The systems, methods, and devices of various embodiments enable a distributed broadcast receiver implementation. In various embodiments, a gateway may redistribute broadcast content to one or more personal devices over a local network via User Datagram Protocol (UDP) delivery or Transmission Control Protocol (TCP) delivery of packets, such as UDP packets. In some embodiments, system time information may be obtained by the personal devices and a local replica of system time information may be maintained within a light server executing within the personal device and functioning as a local synch server. In some embodiments, system time information may be obtained by the gateway and a local replica of system time information may be maintained within a light server executing within the gateway and functioning as a local synch server.

Various embodiments may include methods for distribution of broadcast content including receiving packets, such as UDP packets, sent from a gateway over a local network via a router/switch, obtaining time source information from the gateway, decoding the packets to reconstitute broadcast content included in the packets, and providing the broadcast content to a Hypertext Transfer Protocol (HTTP) proxy executing within the processor of the personal device for output by a media player according to the time source information.

Various embodiments may include methods for distribution of broadcast content from a gateway to one or more personal devices including receiving UDP packets containing broadcast content, obtaining time source information while receiving the UDP packets, establishing a local replica of the time source information, sending the UDP packets to a personal device over a local network via a router/switch, and providing the time source information to the personal device.

Further embodiments include a personal device having a processor configured with processor-executable instructions to perform operations of the methods summarized above. Further embodiments include a personal device including means for performing functions of the methods summarized above. Further embodiments include a non-transitory processor-readable storage medium having stored thereon processor-executable instructions configured to cause a personal device processor to perform operations of the methods summarized above. Further embodiments include a gateway configured with processor executable instructions to perform operations of the methods summarized above. Further embodiments include a gateway including means for performing functions of the methods summarized above. Further embodiments include a non-transitory processor-readable storage medium having stored thereon processor-executable instructions configured to cause a gateway processor to perform operations o of the methods summarized above

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a local network suitable for use with the various embodiments.

FIG. 2 illustrates an example functional architecture of a personal device and gateway.

FIG. 3 illustrates a functional architecture of a personal device and gateway according to an embodiment.

FIG. 4A illustrates an embodiment method for conversion of time in the gateway to coordinated universal time (UTC) per station.

FIG. 4B illustrates an embodiment method for conversion of time in the personal device.

FIG. 5 is a call flow diagram illustrating operations to establish a service between a gateway and a personal device.

FIG. 6 illustrates an embodiment method for signaling reception to provide an Advanced Television Systems Committee (ATSC) 3.0 service.

FIG. 7 illustrates a call flow for an embodiment implementation to deliver encapsulated content.

FIG. 8 illustrates an example functional architecture of a personal device according to an embodiment.

FIG. 9 illustrates a functional architecture of a personal device and a gateway device according to an embodiment.

FIG. 10 illustrates a functional architecture of a personal device and a gateway device according to an embodiment.

FIG. 11 is a call flow block diagram illustrating interactions between a Dynamic Adaptive Streaming over Hypertext Transfer Protocol (HTTP) (DASH) client, local HTTP time synch server, and local HTTP server according to an embodiment method for DASH client synchronization.

FIG. 12 is a call flow block diagram illustrating interactions between a DASH client, local HTTP time synch server, and local HTTP server according to an embodiment method for DASH client synchronization.

FIG. 13 is a process flow diagram illustrating an embodiment method for providing an adjusted Media Presentation Description (MPD) for use in DASH client synchronization.

FIG. 14 is a process flow diagram illustrating an embodiment method for distribution of broadcast content.

FIG. 15 is a process flow diagram illustrating an embodiment method for distribution of broadcast content from a gateway to one or more personal devices.

FIG. 16 is a component diagram of an example personal device suitable for use with the various embodiments.

FIG. 17 is a component diagram of an example gateway suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “personal device” refers to any one or all of cellular telephones, smart phones, personal or mobile multi-media players, personal data assistants (PDAs), laptop computers, personal computers, tablet computers, smart books, palm-top computers, electronic mail receivers, multimedia Internet enabled cellular telephones, gaming controllers, satellite or cable set top boxes, streaming media players (such as, ROKU™ or CHROMECAST™ or FIRE TV™), smart televisions, digital video recorders (DVRs), and similar personal electronic devices which include a programmable processor and memory and circuitry for receiving content within a local network and outputting the content.

As used herein, the term “gateway” refers to any one or all of cellular telephones, smart phones, personal or mobile multi-media players, personal data assistants (PDAs), laptop computers, personal computers, tablet computers, smart books, palm-top computers, electronic mail receivers, multimedia Internet enabled cellular telephones, gaming controllers, tuners, television antennas, streaming media players (such as, ROKU™ or CHROMECAST™ or FIRE TV™), smart televisions, digital video recorders (DVRs), and similar personal electronic devices which include a programmable processor and memory and circuitry for receiving Over-the-Air (OTA) broadcasts of content and providing the content to one or more personal devices over a local network. A gateway device may be any broadcast receiver that has a connection to a local network and that is discoverable on the local network by a personal device.

The term “server” is used to refer to any computing device configured with software instructions to function as a server, such as a master exchange server, web server, mail server, document server, content server, a time synchronization (“time synch”) server, or any other type of server. A server may be a dedicated computing device or a computing device configured with a server software module (e.g., running an application which may cause the computing device to operate as a server). A server module (e.g., server application) may be a full function server module in a dedicated computing device, or a light or secondary server module (e.g., light or secondary server application) that is configured to provide synchronization services among the dynamic databases on receiver devices. A light server or secondary server may be a slimmed-down version of server type functionality that can be implemented on a receiver device or a gateway device to enable such device to support some of the functions of an Internet server (e.g., an enterprise e-mail server) to the extent necessary to provide the functionality described herein.

Various embodiments may include receiving User Datagram Protocol (UDP) packets containing broadcast content at a gateway, sending the UDP packets to a personal device over a local network via a router/switch, and decoding the UDP packets at the personal device and providing the broadcast content to a Hypertext Transfer Protocol (HTTP) proxy of the personal device for output to a media player. In various embodiments, the UDP packets may be sent to the personal device encapsulated in UDP or Transmission Control Protocol (TCP) packets. In various embodiments, the personal device may obtain time source information from the gateway and establish a local replica of the time source information in the personal device such that decoding the UDP packets at the personal device and providing the broadcast content to the HTTP proxy of the personal device for output to a media player uses the local replica of the time source information for coordinating accessing and displaying the broadcast content. Various embodiments may include establishing a local replica of the time source information in a local synch server executing within a processor of the personal device. Various embodiments may include, obtaining, by the gateway, time source information while receiving UDP packets, establishing a local replica of the time source information in the gateway, and providing the time source information from the gateway to the personal device for use in receiving broadcast content by the HTTP proxy within the personal device. In various embodiments, the local replica of the time source information may be established in a local synch server executing within a processor of the gateway.

In various embodiments, local HTTP time sync servers may execute within processors of personal devices and/or local HTTP time sync servers may execute in processors of gateway devices. In some embodiments, the local HTTP time synch server may establish a local replica of the time source information in the personal device and/or in the gateway device. The time source information may be obtained by the personal device and/or gateway device in various manners, including from a preamble of the UDP packets. In some embodiments, the personal device may use the time source information to establish its own local replica of the time source information in the personal device. In some embodiments, a gateway device may obtain time source information while receiving UDP packets, and establish the local replica of the time source information in the gateway. The time source information may be provided from the gateway to the personal device for use in receiving broadcast content by the HTTP proxy within the personal device. In various embodiments, the local replica of the time source information may be used by an HTTP proxy of the personal device and the media player for coordinating, accessing, and displaying content, such as broadcast content included in decoded UDP packets.

In some embodiments, the system time may be established at the Advanced Television Systems Committee (ATSC) 3.0 physical layer by recovering the System Time Clock (STC) time of the bootstrap signal that is carried in the preamble of broadcast content. The receiver can establish a local replica of the system time in the personal device from this information. As an example, the receiver may establish a local replica of the system time in the personal device using the established method for ATSC 3.0. Other methods of determining the system time information may be implemented.

In various embodiments, a local HTTP server may adjust a Media Presentation Description (MPD), such as an MPD received from an ATSC 3.0 physical layer, by adding a reference to a local HTTP time sync server (e.g., the Uniform Resource Identifier (URI) of the local HTTP time sync server) and adjusting a segment availability timeline in the MPD to indicate times corresponding to the local HTTP time sync server time. The reference to the local HTTP time sync server in the MPD may be an indication to a Dynamic Adaptive Streaming over HTTP (DASH) client consuming the MPD that the local HTTP time sync server is the server from which the DASH client should request time synchronization information.

In various embodiments, a local HTTP server may adjust an MPD, such as an MPD received from an ATSC 3.0 physical layer, by adding a reference to the local HTTP time sync server, removing a reference to a remote time sync server in the MPD (e.g., the URI of the remote time sync server), and adjusting a segment availability timeline in the MPD to indicate times corresponding to the local HTTP time sync server time. The reference to the local HTTP time sync server in the MPD may be an indication to a DASH client consuming the MPD that the local HTTP time sync server is the server to which the DASH client is to send time synchronization requests. The reference to the remote time sync server in the MPD may be an indication in the MPD of a time sync server to be used for time synchronization requests at the time the MPD is originally received by the local HTTP server. For example, the reference to the remote time sync server may be a URI of a network time sync server or other time sync server.

In various embodiments, obtaining the time source information may include obtaining the time source information from a preamble of the UDP packets. In various embodiments, the time source information may be provided per station time via network time protocol (NTP) delivery. In various embodiments, the time source information may be provided by a broadcast network per licensed radio frequency (RF) allocation for precision time protocol (PTP) delivery.

In various embodiments, the delivery order of the UDP packets may be preserved. As examples, the delivery order of the UDP packets may be preserved according to Real Time Protocol (RTP), Reliable Data Protocol (RDP), or Stream Control Transmission Protocol (SCTP) protocols (e.g., RFC 3550 Real Time Protocol; RFC 1151 Reliable Data Protocol; and RFC 4960 Stream Control Transmission Protocol, etc.).

Various embodiments may further include determining whether the local network supports UDP transmissions within the local network, sending the UDP packets to the personal device over the local network via the router/switch by UDP in response to determining that the local network supports UDP transmission within the local network, and sending the UDP packets to the personal device over the local network via the router/switch by TCP in response to determining that the local network does not support UDP transmission within the local network. In various embodiments, broadcast traffic handled by the gateway may be tunneled to personal device via UDP transport.

Various embodiments may include determining an Internet Protocol (IP) connection address for content delivery between the gateway and each connected personal device by local network service discovery. Various embodiments may include determining an IP connection address for content delivery between the gateway and each connected personal device by assignment of predefined addresses according to an order of connection. Various embodiments may include determining a port number for content delivery between the gateway and each connected personal device by assignment of predefined port numbers according to an order of connection. Various embodiments may include discovering, in-band, available UDP connections via TCP connection between the personal device and gateway.

In some embodiments, the delivery of the individual Physical Layer Pipe (PLP) content may be on a dedicated IP connection per PLP delivered and personal device attached to the gateway. In some embodiments, the delivery of the individual PLP content may be on a dedicated port number per PLP delivered and personal device attached to the gateway.

Various embodiments may include tuning the gateway by the personal device. In some embodiments, tuning the gateway may be accomplished via a tvcontrol.api (e.g., a television control application program interface (API)). In some embodiments, tuning the gateway may include using a custom command for a specific frequency. In some embodiments, the direct control of the gateway may be provisioned by a personal device application. In some embodiments, a first currently connected personal device has control of a first tuner resource of the gateway, a second currently connected personal device has control of a second tuner resource of the gateway, and/or personal devices joining after all tuner resources of the gateway are reserved may have a choice of a tuner resource without control of the tuner resource's tuned frequency.

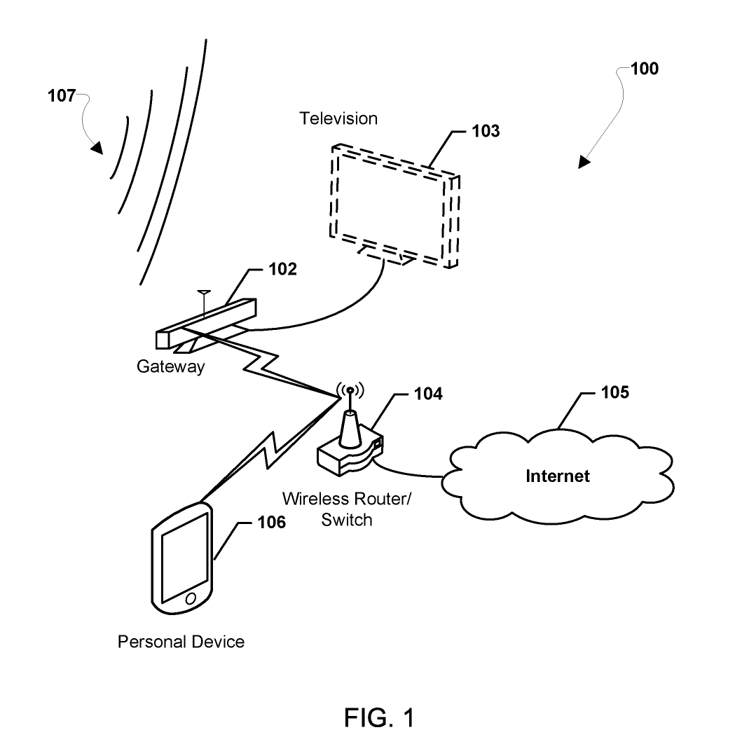

FIG. 1 illustrates a local network system 100 suitable for use with the various embodiments. The local network system 100 may include multiple devices, such as a gateway 102, a router/switch 104, one or more personal devices 106 (e.g., a tablet), and optionally a television 103. As examples, local network 100 may be a network located within a user's home or other local premises networks such as a public café, airport lounge, etc. The router/switch 104 may be connected to the Internet 105. The gateway 102 may include an antenna to receive Over-the-Air (OTA) transmissions of broadcast content 107, such as OTA transmissions of broadcast television services transmitted according to the ATSC standards (e.g., ATSC 2.0, ATSC 3.0, etc.). The gateway 102 may optionally be connected to the television 103 and may output content to the television 103 for display to a user. While illustrated as separate devices in FIG. 1, in an alternative configuration the gateway 102 may be a component of the television 103 and/or may share one or more component with the television 103. For example, the gateway 102 may share an antenna with the television 103. As another example, the gateway 102 may be located within the television 103 and the OTA transmissions of broadcast content 107 may be received directly by the television 103.

The gateway 102 may be in communication with the router/switch 104 via one or more wireless or wired connections, for example via Wi-Fi connections. The personal device 106 may be in communication with the router/switch 104 via one or more wired or wireless connections, for example via Wi-Fi connections. The gateway 102 and personal device 106 may exchange data with one another via the respective connections (wired or wireless) to the router/switch 104 according to one or more transport protocols (e.g., HTTP, TCP, IP, UDP, etc.).

There are various different configurations in which the gateway 102 and a personal device 106 may partition functionality to output content to a user. Some approaches may have fewer security or other type issues than others. Security problems may become particularly acute when the gateway 102 is used for content redistribution to personal devices 106 within a local network 100 e.g. inside a home network. In such cases, the personal device 106 may discover the gateway 102 (or vice versa), and the at least two parties may set up some form of 2-way secure communication. When the content that the gateway 102 is redistributing (e.g., forwarding, passing, etc.) is downloaded from a broadcast medium (e.g., ATSC, evolved Multimedia Broadcast Multicast Service (eMBMS) standards, Digital Video Broadcasting (DVB), etc.), the restrictions regarding the content (e.g., access controls) may carry over from the broadcaster providing the content OTA to the gateway 102 and to the personal device 106.

Regardless of how the functionality is portioned between the gateway 102 and the personal device 106, discovery must take place in order to establish communications between the gateway 102 and personal device 106. In an embodiment, broadcast traffic handled by the gateway 102 may be tunneled to personal device 106 via UDP transport. However, the router/switch 104 may or may not be configured to pass UDP traffic from the gateway 102 to the personal device 106. Various router/switches 104 do not allow UDP traffic to pass through the router/switches 104 between devices on the local network 100. There are also router/switches 104 that may be configured to allow UDP to pass between devices on the local network 100 side after installation, but that do not default to passing UDP on the local network 100 side. Thus, in some systems, the capability to pass UDP for a given router/switch 104 cannot be relied upon.

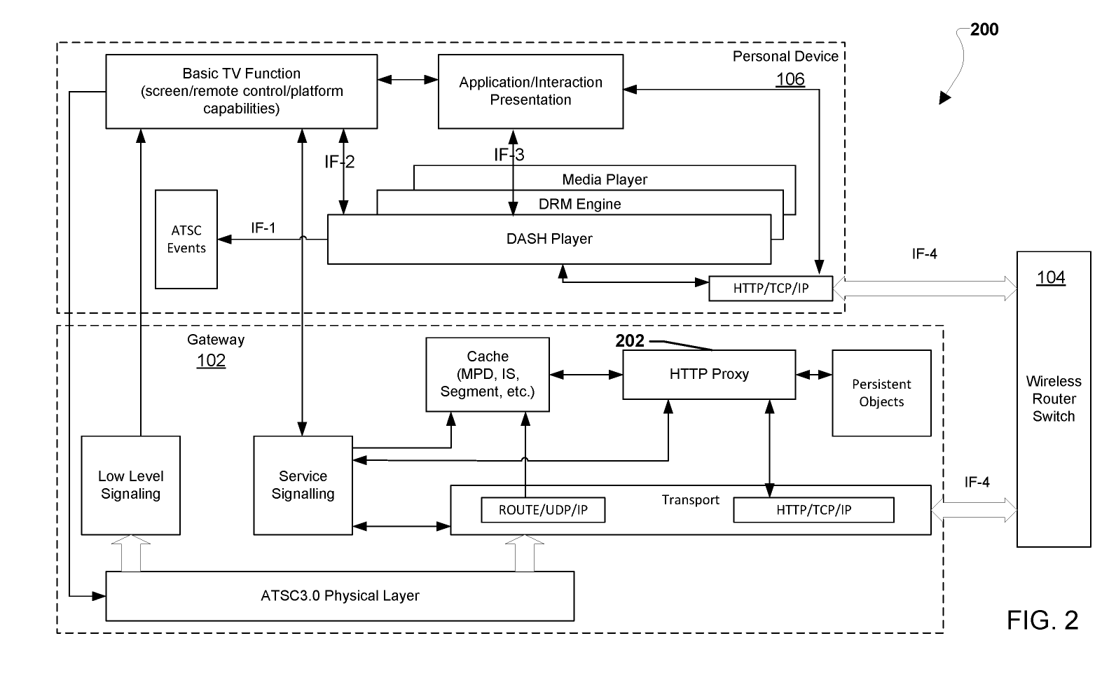

FIG. 2 illustrates an example functional architecture 200 of the personal device 106 and gateway 102 configured to redistribute content from the gateway 102 to the personal device 106 via the router/switch 104. As illustrated in FIG. 2, the receiver architecture has been split at or near the HTTP interface at the input to the media player. In the architecture 200 illustrated in FIG. 2, a DASH client is the player. The physical layer of the gateway 102 is an ATSC (e.g., ATSC 2.0, ATSC 3.0, etc.) or another broadcast format physical layer (e.g., eMBMS, DVB, etc.). The architecture 200 resolves the issue with UDP from the ATSC 3.0 or other broadcast physical layer not being able to transit the local network 100 side of the router/switch 104. However, the architecture of the local network 100 places a significant burden on the gateway 102 to support, for example, possibly multiple instances of an ATSC 3.0 receiver stack in the gateway 102. There are also possible security issues with splitting the receiver across two separate entities related to the HTTP proxy 202 location. There is the potential to have to duplicate several functions multiple times, e.g., once for each instance of a personal device 106 connected to the gateway 102.

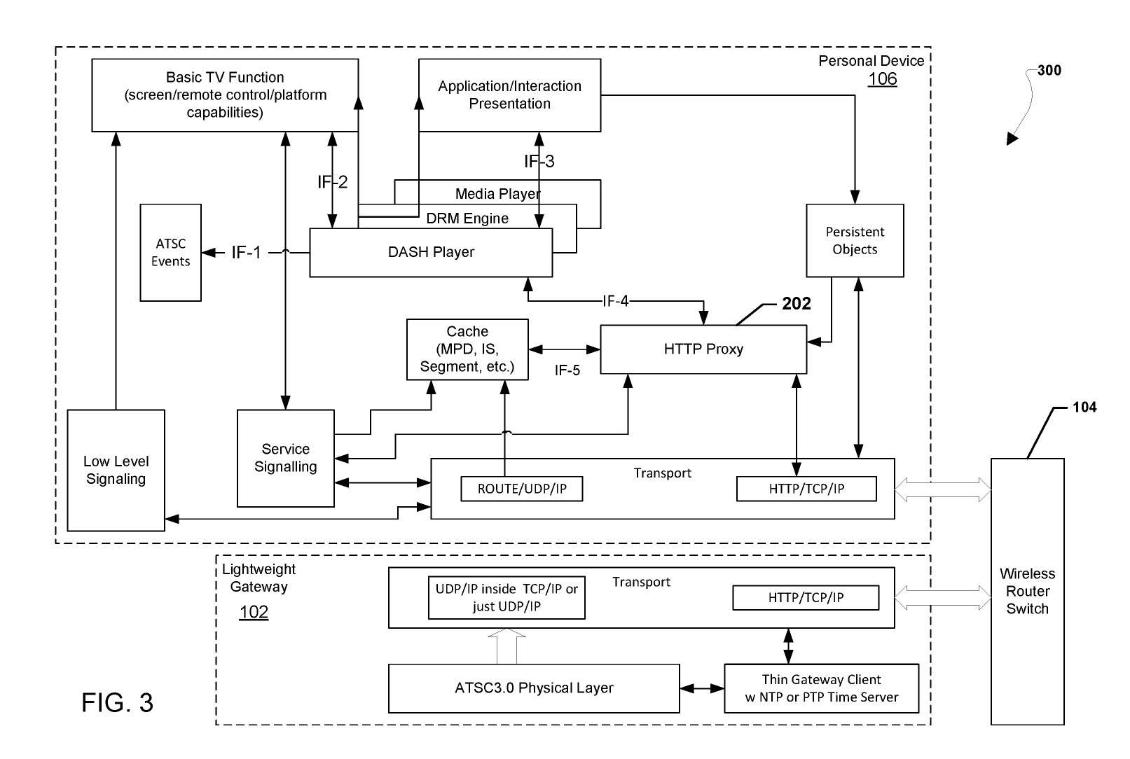

FIG. 3 illustrates a modified functional architecture 300 of a personal device 106 and gateway 102 according to an embodiment. The architecture 300 is similar to architecture 200, except that the HTTP proxy 202 is moved off the gateway 102 to the personal device 106. The architecture 300 may improve discovery operations for the personal device 106 and/or gateway 102. For example, assuming the gateway 102 supports a standard local network discovery protocol (e.g. Simple Service Discovery Protocol (SSDP), etc.), the process running on the personal device 106 that instantiates route reception may also discover the gateway 102. An application running in user space on the personal device 106 (particularly in a browser) may not be able to discover the gateway 102 on its own when the HTTP proxy 202 is located off the personal device 106. In the architecture 300 illustrated in FIG. 3, the management data flows are entirely inside the personal device 106 enabling discovery by an application running in user space on the personal device 106 (particularly in a browser).

The architecture 300 may improve security for the personal device 106 and/or gateway 102. As the whole of the HTTP proxy 202 may be contained inside a single device, internal references may not be subject to external redirection. For example, the domain name of the HTTP proxy 202 for mediating DASH Segment requests from the DASH client may be set to ‘localhost’, which may be considered a secure origin, thereby providing a secure architecture. Additionally, the UDP connection (which delivers the broadcast content) between the personal device 106 and gateway 102 may be secured using several approaches, such as by datagram transport layer security (DTLS) as described in Internet Engineering Task Force (IETF) Request for Comments (RFC) No. 4347, by proprietary payload encryption, and by a combination of DTLS and proprietary payload encryption. The TCP connection between the gateway 102 and personal device 106 may be secured through various approaches, such as transport layer security (TLS). DTLS or TLS may use in-band mechanisms to establish the certificate for the connection, or may use out-of-band methods to pin the connection to a specific certificate.

The architecture 300 may enable broadcast UDP to be delivered over (e.g., transit across) the local network 100. In various embodiments, transit of the local network 100 may be accomplished by UDP when UDP delivery is not blocked. In various embodiments, transit of the local network 100 may be accomplished by TCP depending on the local network 100 IP environment.

The architecture 300 may enable support for multiple personal devices 106 in the local network 100. The support for a given instance of a personal device 106 may be almost entirely present in the personal device 106 in architecture 300. Multiple personal devices 106 may attach to the gateway 102 without imposing a substantial burden on the gateway 102. For example, there may be four streams delivered to each personal device 106 per active service, but these streams may be merely copies of physical layer delivered (possibly still ATSC Link Layer Protocol (ALP) encapsulated) IP streams delivered to each personal device 106. Depending on business rules, different personal devices 106 may be given different levels of access. For instance, if a personal device 106 does not support a form of digital rights management (DRM) encryption that is leveraged by content being delivered by the currently-acquired broadcast service, the connection may be refused or terminated to reduce the load on the gateway 102.

The architecture 300 may enable execution of enhancement applications. As none of the media assets required for an enhancement application are stored in the gateway 102 in architecture 300, each personal device 106 may be responsible for its own media assets. This may be most appropriate because the personal devices 106 may determine/store its user's preferences and demographics. There are also possible privacy issues with a gateway 102 tracking/determining the specifics of an individual user's demographics. This particularly acute if the gateway 102 belongs to a Wi-Fi local area network providing public access (e.g. café, airport lounge, etc.).

The architecture 300 may enable a gateway thin client as the gateway 102 to perform minimal functionality in order for the system to operate. Further, the architecture 300 may enable code reuse as most of the personal device 106 software for displaying the actual content may leverage a commercial television implementation's display operations. Further, the architecture 300 may enable hardware reuse as the tuner function of a standard TV may be reused as a gateway 102, when the TV may be in sleep mode.

The architecture 300 illustrated in FIG. 3 may be implemented by a functional broadcast receiver with the combination of a thin client/broadcast tuner, for example gateway 102 and a personal device with a dedicated application, for example personal device 106.

The personal device 106 may be granted access to the local network 100 by any method, including password entry/verification, Media Access Control (MAC) address filtering, certificate pinning, confirmation of possession of private key, and/or personalized authentication mechanisms present on the device (e.g., fingerprint reader). The personal device 106 may connect to the correct app store for the device type and may download an application for a specific type of gateway 102 to be installed. The personal device application may be targeted at a specific brand of gateway 102. This may be accomplished by specific download or user interface selection in the personal device application.

The gateway 102 may be connected to the local network 100 IP infrastructure either by a wired or wireless connection optionally utilizing Wi-Fi Protected Access (WPA) or other wireless security. Recognition of the gateway 102 by Wi-Fi MAC address may be straightforward to configure. For example, the MAC address of the gateway 102 may be printed on a label of the gateway 102. Also, the personal device application may open a web interface on the gateway 102 using a fixed preconfigured address known to the personal device application. Many of the installation methods may involve configuring or reconfiguring the access point (e.g., the router/switch 104), which may not be as straightforward for users, but are possible implementations. A wired connection of the gateway 102 to the router/switch 104 may eliminate the need for wireless configuration of the initial connection to the access point, which may be convenient for users. If the gateway 102 is part of a broadcast-enabled consumer device (e.g., a smart TV), any associated user-driven configuration methods may apply for establishing local connectivity.

The personal device 106 may discover the gateway 102 once connected to the local network 100 by a number of methods including, but not limited to, a well-known address for a configuration page and/or local discovery protocols (SSDP, multicast Domain Name Server (mDNS), etc.).

ATSC 3.0 and other broadcast formats may depend on accurate time established between the studio/station and the receiver. In a television, there may be accurate time available to the device stack from the physical layer that is converted to coordinated universal time (UTC) for general application by at least the browser and DASH client.

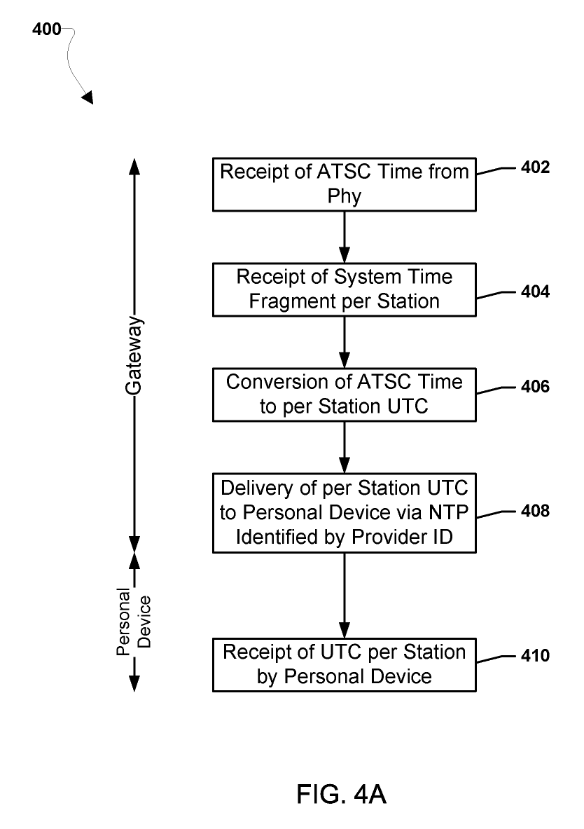

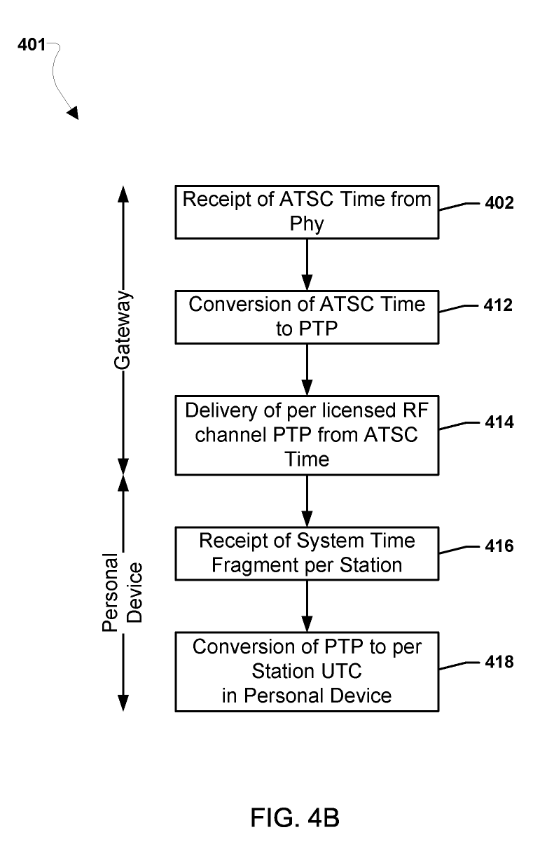

In a distributed implementation architecture, such as the architecture 300 of FIG. 3, the personal device 106 may establish accurate UTC via a network time protocol (NTP) or precision time protocol (PTP) server in the gateway 102. The address of the time server in the gateway 102 may be fixed and known to a personal device 106 by virtue of the per gateway application or discoverable via local network service discovery protocols. There may be a distinction among the NTP and PTP methods as shown in FIGS. 4A and 4B. For example, the construction of UTC may be on a different side of the interface depending on the method at the gateway 102. Use of PTP may simplify the gateway 102 implementation.

FIG. 4A illustrates an embodiment method 400 for conversion of time to UTC via NTP in the gateway 102. In various embodiments, the operations of method 400 may be performed by a processor of a gateway, such as gateway 102, and a processor of a personal device, such as personal device 106, in communication with the gateway 102.

In block 402 the gateway processor may receive an indication of ATSC time or other time delivery method from the physical layer.

In block 404 the gateway processor may receive a system time fragment per station.

In block 406 the gateway processor may convert ATSC time to per station UTC time.

In block 408 the gateway processor may deliver per station UTC to the personal device via an NTP server identified by provider ID.

In block 410 the personal device processor may receive the UTC per station time.

FIG. 4B illustrates an embodiment method 401 for conversion of time to UTC via PTP in the personal device 106. In various embodiments, the operations of method 401 may be performed by a processor of a gateway, such as gateway 102, and a processor of a personal device, such as personal device 106, in communication with the gateway 102.

As discussed above, in block 402 the gateway processor may receive an indication of ATSC time from the physical layer.

In block 412 the gateway processor may convert the ATSC time to PTP and in block 414 may deliver, on a per licensed RF channel basis, PTP from ATSC time to the personal device.

In block 416 the personal device processor may receive the system fragment per station.

In block 418 the personal device processor may convert PTP to per station UTC. The UTC construction in the personal device 106 may be more consistent with the general concept of minimizing per Station or per Service processing at the gateway 102.

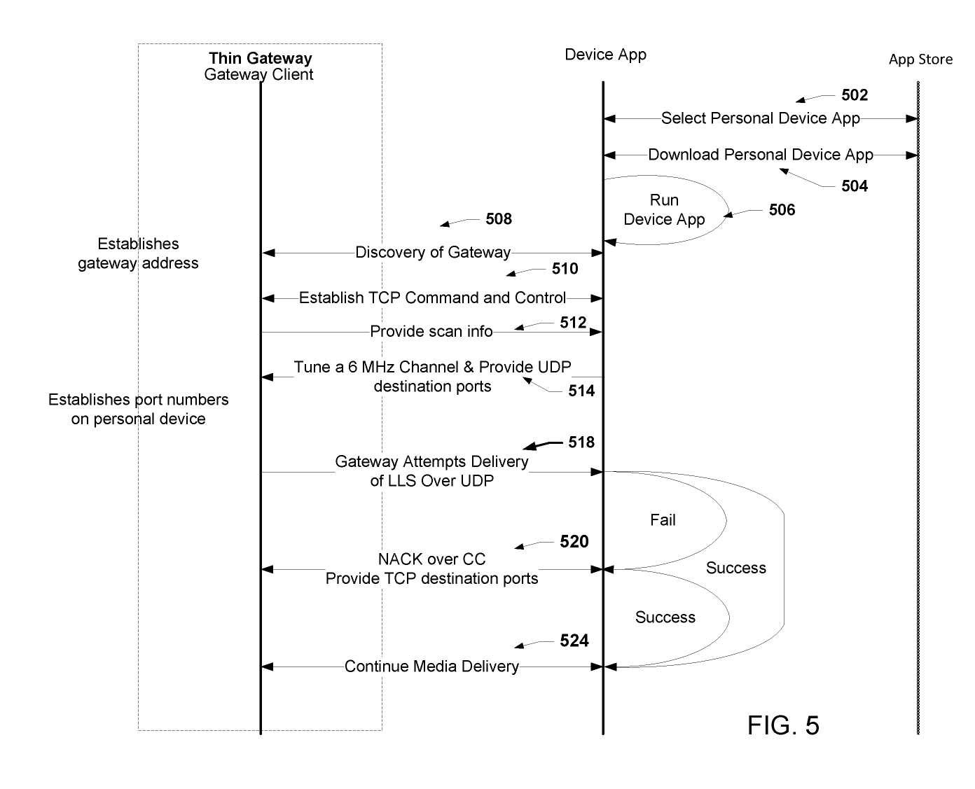

FIG. 5 is a call flow diagram illustrating operations performed by a personal device application running on a processor of a personal device, such as personal device 106, a gateway client running on a processor of a gateway, such as gateway 102, and an application store or other application provisioning location to establish a service between a gateway and a personal device.

In operation 502 the personal device application may be selected by the user of the personal device from an application store and downloaded to the personal device in operation 504. The personal device application may then run on the personal device in operation 506.

In an embodiment, the personal device application may discover the gateway client in operation 508 and may communicate with the gateway via a command and control interface in operation 510. The personal device application may be pre-configured to connect to a particular gateway, or the personal device application may perform some sort of discovery on the local network to find the gateway, using mDNS, DNS-SD, or other similar discovery protocol. The discovery protocol allows the personal device to find a command and control interface over which it can communicate with the gateway. The command and control interface operates over TCP, so it will function in every anticipated application environment including a local network without router/switch reconfiguration. After the establishment of the command and control channel and retrieval of available frequencies, the personal device may tune to a selected channel by providing to the gateway the desired channel and the target UDP port numbers for media delivery.

The ATSC 3.0 physical layer receiver in the gateway device may determine, from the physical layer preamble, the Physical Layer Pipes (PLPs) that contain Low Level Signaling (LLS). The LLS and Service Layer Signaling (SLS) referenced by LLS provides specific service discovery information for a given television station. The gateway upon establishment of receipt of LLS from ATSC 3.0 waveform will deliver the LLS(s) and associated any link mapping table (LMT) for the currently tuned station(s).

The gateway may have performed a scan of possible very high frequency (VHF) and ultra-high frequency (UHF) channels upon installation. The LMT contains a map of PLPs to IP over the air addresses/ports associated with ATSC 3.0 services (referenced by the service list table (SLT) in LLS) that is delivered to the personal device. The personal device may also initiate a scan from the user interface of the personal device application, or via the gateway web interface. The gateway may store a list of active RF frequencies, e.g., the frequencies that have active ATSC 3.0 or ATSC 1.0 transmissions present. The gateway may not support reception of ATSC 1.0 services, but the ATSC 1.0 waveform may be converted to ATSC 3.0 format at a future date, so the gateway may be confirmed to store and/or determine that the ATSC 1.0 waveform is a licensed RF allocation. The Personal Device may also be persistently stored the frequency map, but this does not add much value, unless an additional gateway is being installed. The gateway tuner may be controlled by various methods, including by the W3C TV Control API. Control need not be executed from the browser.

Accordingly, the gateway may have already conducted a scan of available frequencies and may provide the scan information to the personal device in operation 512, but if not, the personal device may initiate a scan on the gateway. Upon completion of the scan the gateway may share the valid frequencies for service.

In operation 514 the personal device may attempt to tune the gateway to a specific 6 MHz channel and provide the UDP destination ports via command and control defined in operation 510. If the gateway has accessed the SLT, the gateway may respond to channel numbers from the personal device, otherwise the personal device may determine the presence of a specific channel number upon receipt of the LLS. The LLS may be among the first data sent to the personal device in operation 518. The personal device may persistently store major and minor channel numbers upon their discovery.

If media data is successfully delivered to the provided UDP port on the personal device, the media delivery via UDP may continue in operation 524. If UDP delivery is indicated as failing in operation 520, the personal device may provide TCP destination ports via command and control defined in operation 510 and continue media delivery via TCP in operation 524. As discussed above, the gateway attempts UDP delivery to the Personal Device. If this fails, the personal device may notify the gateway by providing target TCP port numbers to the gateway to allow for delivery of the broadcast-delivered UDP to the personal device for the selected channel via TCP connection. This may be accomplished by delivering the data directly in TCP or may be accomplished via TCP-encapsulation. In this manner, the gateway may determine whether or not a local network (or more specifically one or more elements of the network such as the router/switch or personal device) supports UDP transmissions. Any number of encapsulation methods that may be used in the various embodiments, and any encapsulation method may be used in the various embodiments. The gateway may establish up to N (support for at least 4) connections (via UDP or TCP) for media and signaling delivery per Service. For ATSC 3.0 applications, a value of N equals 4 may be the one requirement, but other greater or lesser N values may be used in the various embodiments.

In an embodiment, when ATSC 1.0 may be present, the MPEG2 transport may be wrapped in IP for delivery to the personal device. Markets that do not currently have fully occupied UHF spectrum may not immediately transition to ATSC 3.0, so ATSC 1.0 support may enable support in such markets. The delivery of one service of ATSC 3.0 can require the concurrent receipt of the data from up to 4 PLPs. The receipt of the low level signal(s) (LLS(s)) and related LMT(s) may allow the personal device to select the IP streams that contain Service Level Signaling (SLS) for services. The media and signaling delivered via ATSC 3.0 may have specific temporal significance. The encapsulation method of data delivered via TCP may enable detection and correct of out of order delivery.

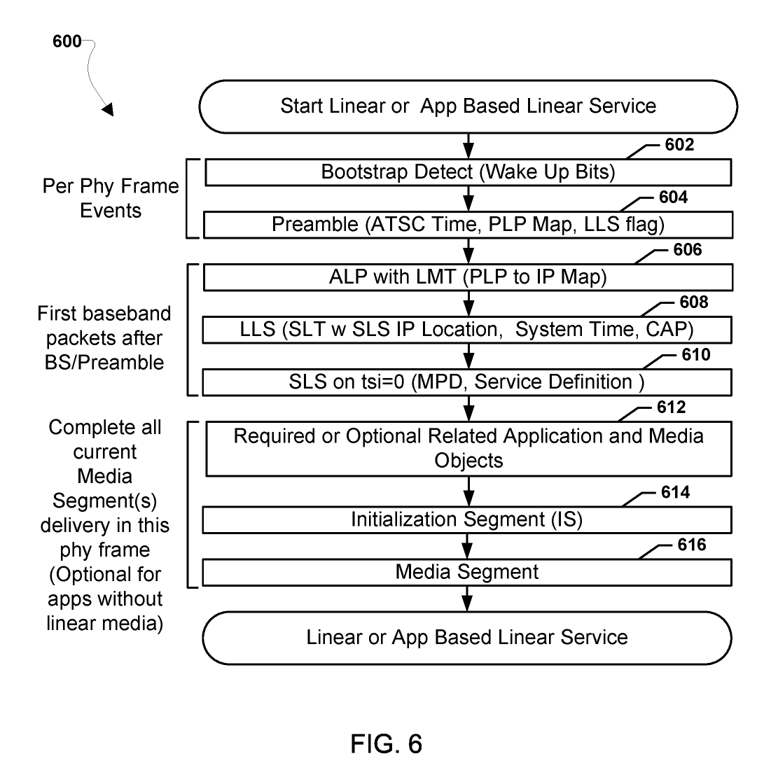

FIG. 6 illustrates an embodiment method 600 for signaling reception to provide an ATSC 3.0 service. The operations of the method 600 may be performed by any device to provide an ATSC 3.0 service, such as a gateway 102 and/or personal device 106, in any architecture. Upon start the method 600 may include per physical frame events, such as bootstrap detect 602 and preamble acquisition 604. Additionally, first baseband packets after bootstrapping and preamble may provide ATSC Link Layer Protocol (ALP) with LMT 606, LLS 608, SLS on transport session identifier (tsi) tsi=0 610, and required or optional related application media objects 612. Completing all the current media segments delivery in the current physical frame may be optional for applications without linear media and may include an initialization segment 614 and media segment 616 and the device may continue providing the linear or application based linear service.

In a lightweight or thin gateway, the gateway may unwrap the LLS bearing PLP stream in order to determine the IP streams according to the LMT contained in the ALP encapsulation protocol. The personal device may request individual IP streams or the complete content of specific PLPs. If the personal device is requesting IP streams, the gateway must open ALP streams from appropriate PLPs in order to deliver the desired IP streams.

In an implementation, the gateway may pass entire ALP stream(s) via UDP or TCP to the personal device. The personal device reads LMT, SLT and if required requests PLP bearing SLS. The SLS and SLT may have been delivered jointly in a common PLP. The personal device may select desired PLPs according to desired IP streams per Service. Alternatively, the personal device may select single PLP delivery, which may be a primary operational mode and may be simpler than multiple PLP delivery. As the maximum bit rate possible (e.g., greater than 20 Megabits per second (Mbps)) may be challenging to sustain in some local networks, the personal device application may select delivery of specific IP streams in response to there being difficulty in delivering streams at PLP level. The IP streams from a given PLP may be delivered in the order that they are delivered from the physical layer.

One advantage of the various embodiments may be that the gateway may be very simple. The gateway may be tuned to a desired licensed 6 megahertz (MHz). The gateway may find the LLS(s) and forward them to the personal device. The personal device may manage Service reception once the LLS(s) are received. The gateway may deliver up to four LLS(s) per RF instance concurrently, and may cycle through additional LLS(s) in groups of four if more than four are present. LLS(s) may be sent in order of reception.

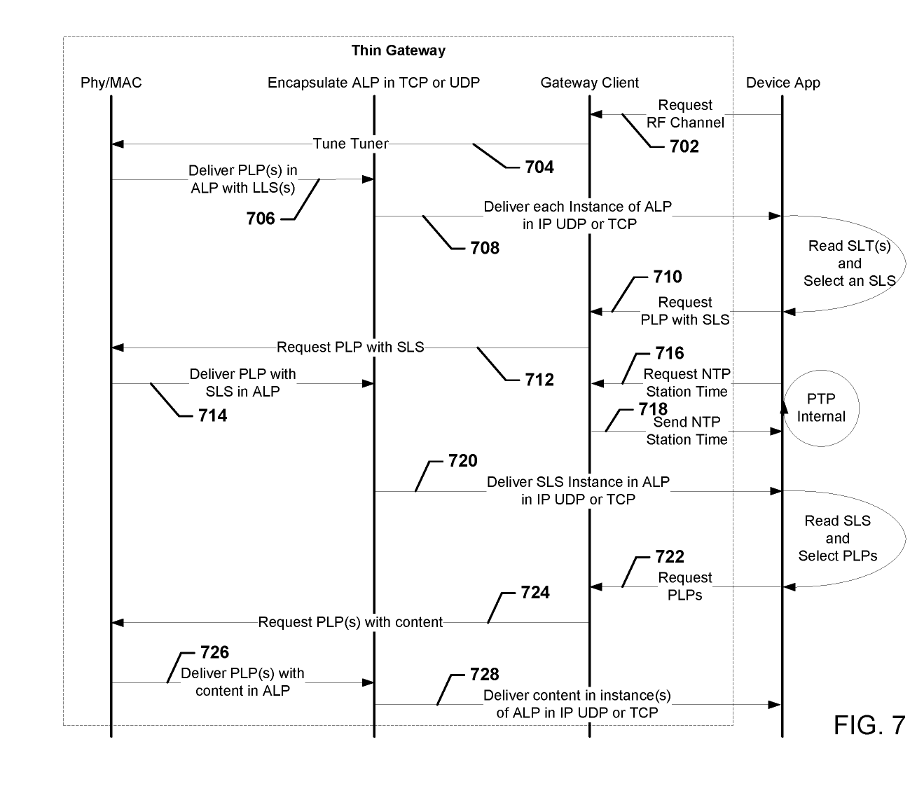

FIG. 7 illustrates a call flow for an embodiment implementation to deliver encapsulated content. The operations illustrated in FIG. 7 may be performed by a personal device application running on a processor of a personal device, such as personal device 106, and a gateway client running on a processor of a gateway, such as gateway 102. The personal device application may request an RF channel from the gateway client in operation 702.

In operation 704 the gateway client may cause the physical/MAC layer to tune the tuner to the requested channel.

In operation 706 the PLP(s) in the ALP with LLS(s) may be delivered to the encapsulation layer. The encapsulation layer may be a portion of gateway that encapsulates ALP in TCP or UDP. The encapsulating protocol for delivery of ALP or contained UDP streams may be, but are not constrained to the following protocols, which can be used to preserve/reconstruct in order delivery: RFC 3550 (RTP) Real Time Protocol; RFC 1151 (RDP) Reliable Data Protocol; and RFC 4960 (SCTP) Stream Control Transmission Protocol.

In operation 708 each instance of ALP or selected IP streams may be delivered to the personal device application in IP UDP or TCP. The personal device may read the SLT(s) and select an SLS and request a PLP with the SLS in operation 710.

The gateway client may send the request for PLP with SLS to the physical/MAC layer in operation 712. Additionally, in operations 716 and 718 the device application may request NTP station time and receive NTP station time from the gateway client or perform internal PTP operations to coordinate time.

In operation 714 the PLP with SLS may be delivered in ALP to the encapsulation layer, which may deliver the SLS instance in ALP in IP UDP or TCP to the device application in operation 720. The personal device application may read the SLS and select PLPs and request those PLPs in operation 722, and the gateway client may request the PLP(s) with content in operation 724.

The PLP(s) with content may be delivered in block 726, and the encapsulation layer may deliver content instance(s) of ALP in IP UDP or TCP in operation 728 to the personal device application. A benefit of preserving the ALP wrapper into the personal device is that data delivery order is preserved among the IP streams, which may have been intentionally organized for best performance. An order of delivery may also be preserved for a subset of IP streams in a PLP by discarding any undesired streams.

There may be an OTA set of IP addresses for the various IP streams delivered to the gateway. The architecture 300 described with reference to FIG. 3 avoids potential conflicts among multiple personal devices or other equipment by allowing the independent assignment of IP addresses to the various delivered ALP encapsulated data to each personal device. There may be one IP connection per ALP stream or collection of broadcast-delivered instances of UDP. The assignment of IP addresses between the gateway and personal device(s) may be according to addresses per a personal device application defined method established via the dedicated connection from an individual personal device to the gateway or addresses constructed by mapping of Base Station Identifier (BSID), Provider Identifier (ID), and Service ID, which in aggregate may be unique. Similarly, the port numbers under the known IP addresses may be utilized to deliver encapsulated ALP and/or encapsulated IP streams may be organized to be systematically unique.

The receipt and reconstruction of services may be dependent on time. The time delivered to the gateway may be specific to an individual television station. The various media services of this station may all be synchronized to a single instance of a common UTC wall clock. The personal device may utilize the provider ID associated with a station to assure that the time base being utilized in the personal device is from the correct station. While all time bases should be the same, the individual stations may have control over certain aspects of time, so there must be unique time keeping per station. Time may reset upon a station change, but time should not change nor need to change on an intra-station service change.

The IP address for the time transaction per personal device may be assigned according to a defined list within the gateway and the personal device utilizing the next available upon connection. A similar scheme may be applied to use of port numbers under a common address. The assignment may loop upon last list member being assigned. For PTP there may be a single instance per licensed RF allocation per tuner resource. Time may run on multiple IP addresses and/or port numbers for the same RF licensed 6 MHz, as each personal device may be independent in its use of time and there may be multiple stations present on a single tuner.

In various embodiments, the call flow among the various personal devices and the gateway may be proprietary or may be based on existing World Wide Web Consortium (W3C) methods. For example, the existing tvcontrol.api of W3C may be used to control the gateway tuner. This need not be the full implementation and should likely be restricted to a subset of the available commands. Some commands of that may be implemented may include: “Promise<sequence<TVTuner>>getTuners ( )”; “Promise<sequence<TVChannel>>getChannels ( )”; “Promise<void>setCurrentChannel ( )”; and “boolean isRescanned”.

There may be no provision to request a specific frequency from the “tuner”, which drives a requirement for the understanding of channel numbers into the gateway. This may be undesirable in some instances. The gateway may be aware of the mapping of channel numbers frequency, which may be discoverable from ATSC 3.0 signaling, but may add complexity. If the gateway is integrated within a viewing device, such as a television (TV), then tuner control commands originating from the personal device may not be able to override native tuner settings. There is a potential for a similar issue when multiple personal devices are attaching to a Gateway, e.g., there can be conflicting requests for the use of a given tuner resource.

One solution may be that the first connected personal device may have control of a tuner resource unless the tuner resource is imbedded in an integrated platform such as a television. Alternatively, other methods to assign primary control may be implemented in various embodiments. For example, the second currently connected personal device may have control of a second resource. As another example, personal devices joining after all tuner resources are reserved may have a choice of tuner, but no control over the frequency of that selected tuner. A personal device may select service from any channels available on a various instance of a tuner.

In some embodiments, a local HTTP time sync server may be implemented within a receiver device or gateway device to replicate system time received from a system time server, and provide timing synchronization to a DASH client. Such embodiments reduce the need for the DASH client to request and receive time information from the remote server as the information is accessible locally. The Local HTTP time sync server and local HTTP proxy server (e.g., local DASH content providing HTTP proxy 202 in FIGS. 1-7) are synchronized to one another. By adjusting the Media Presentation Description (MPD) to signal or indicated that the local HTTP time sync server is the location for the DASH client to send time sync requests, the DASH client may synchronize to local HTTP time sync server. Additionally, the MPD may be updated to reflect local times for segment availability, e.g., availability times synchronized to local HTTP time sync server time. The local HTTP server may make segments available at the local synchronized times, and the DASH client may request content segments from the local HTTP proxy server according to the local synchronized time. This enables the DASH client to be served segments at requested local times and function correctly, while reducing problems that may be caused by network delays, varying round-trip times, brief network outages or poor communication links, etc.

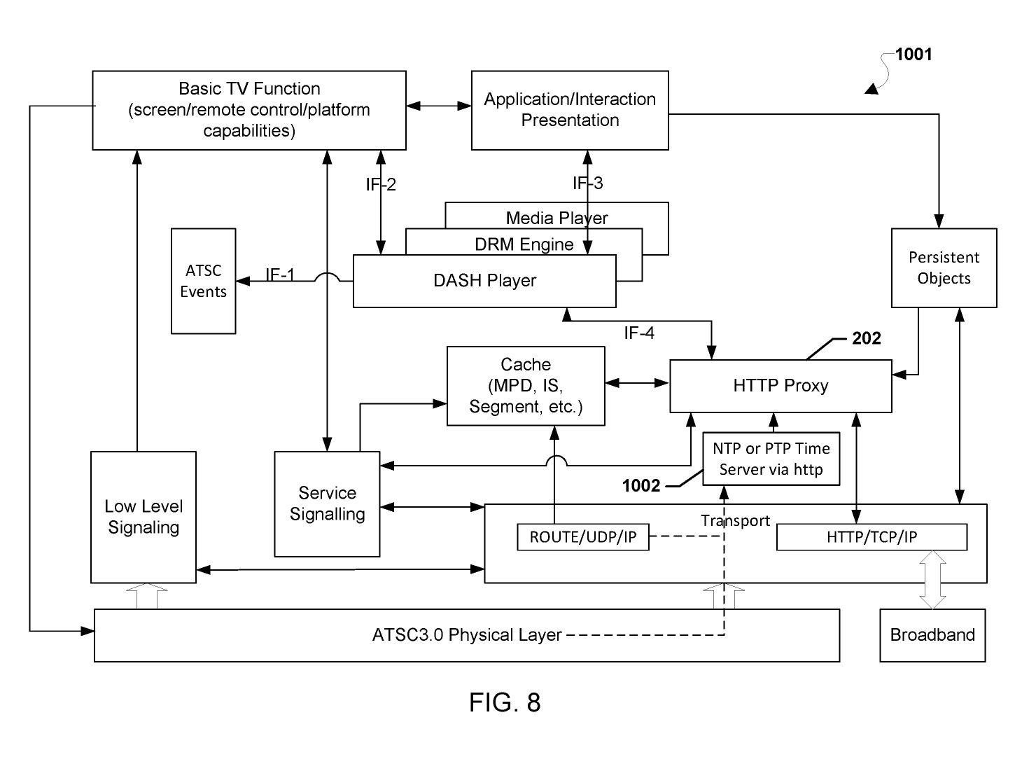

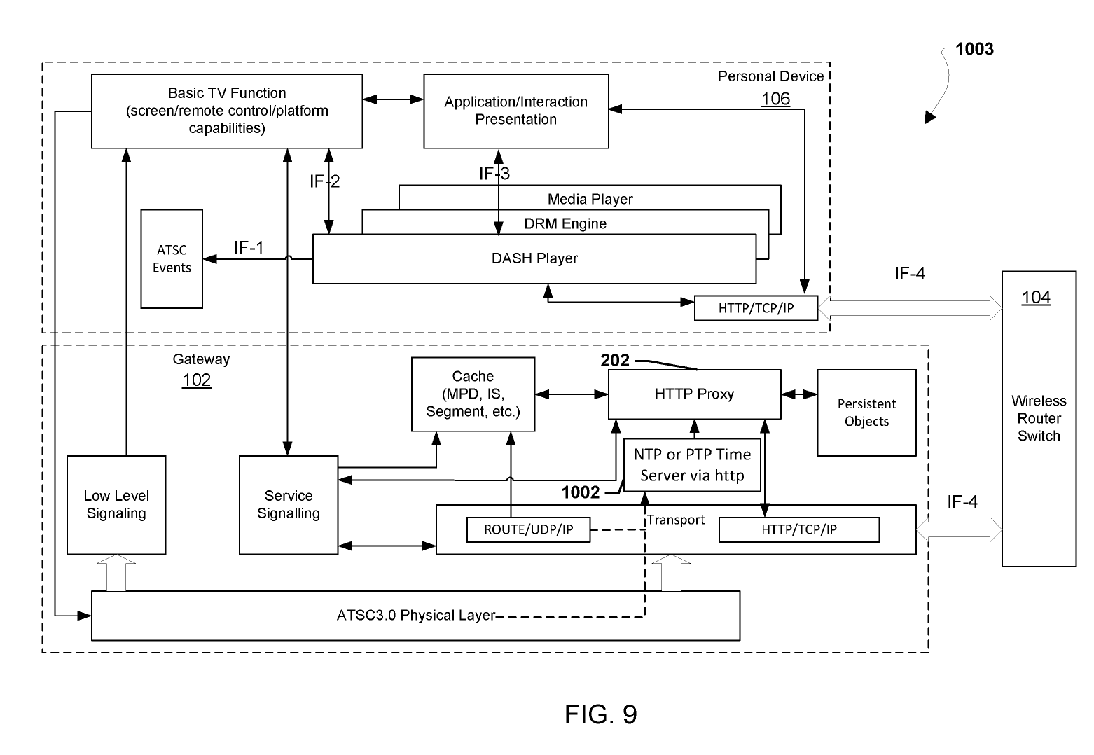

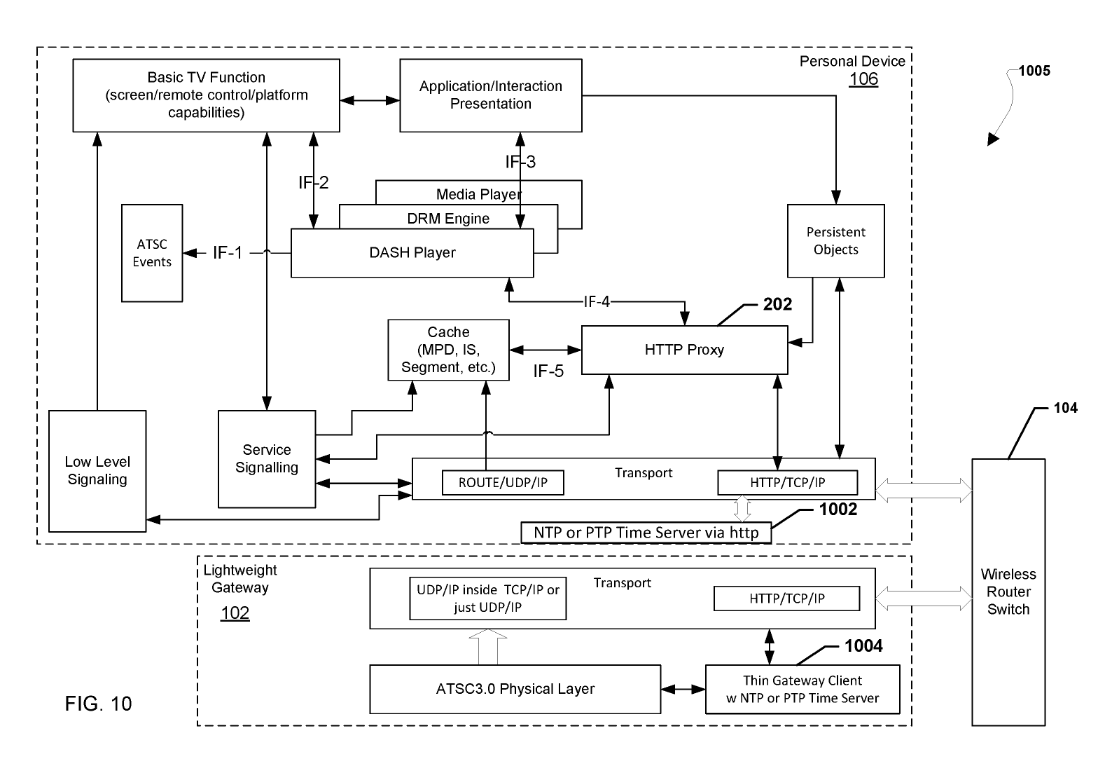

In various embodiments, the local HTTP time sync server synchronizes with the local HTTP proxy server providing content to DASH client. The local HTTP time sync and the local HTTP proxy server may be implemented within personal devices or the gateway. Basically, the same techniques may be applied regardless of whether the local HTTP time sync server and local HTTP proxy server are implemented in a personal device (as illustrated FIGS. 8 and 10) or in the gateway (as illustrated in FIG. 9).

In various embodiments, local HTTP time sync servers may execute within processors of personal devices and/or local HTTP time sync servers may execute in processors of gateway devices. In various embodiments, the local HTTP time synch server may establish a local replica of the time source information in the personal device and/or in the gateway device. The time source information may be obtained by the personal device and/or gateway device in various manners, including from a preamble of the UDP packets. In some embodiments, the personal device may use the time source information to establish its own local replica of the time source information in the personal device. In some embodiments, a gateway device may obtain time source information while receiving UDP packets, and establish the local replica of the time source information in the gateway. The time source information may be provided from the gateway to the personal device for use in receiving broadcast content by the HTTP proxy within the personal device. In various embodiments, the local replica of the time source information may be used by an HTTP proxy of the personal device and the media player for coordinating, accessing, and displaying content, such as broadcast content included in decoded UDP packets.

In some embodiments, the system time may be established at the ATSC 3.0 physical layer by recovering the STC time of the bootstrap signal that is carried in the preamble of broadcast content. The receiver can establish a local replica of the system time in the personal device from this information. For the purposes of this disclosure this is the established method for ATSC 3.0. Other methods of determining the system time information may be implemented.

In various embodiments, a local HTTP server may adjust an MPD, such as an MPD received from an ATSC 3.0 physical layer, by adding a reference to a local HTTP time sync server (e.g., the URI of the local HTTP time sync server) and adjusting a segment availability timeline in the MPD to indicate times corresponding to the local HTTP time sync server time. The reference to the local HTTP time sync server in the MPD may be an indication to a DASH client consuming the MPD that the local HTTP time sync server is the server from which the DASH client should request time synchronization information.

In various embodiments, a local HTTP server may adjust an MPD, such as an MPD received from an ATSC 3.0 physical layer, by adding a reference to the local HTTP time sync server, removing a reference to a remote time sync server in the MPD (e.g., the URI of the remote time sync server), and adjusting a segment availability timeline in the MPD to indicate times corresponding to the local HTTP time sync server time. The reference to the local HTTP time sync server in the MPD may be an indication to a DASH client consuming the MPD that the local HTTP time sync server is the server to which the DASH client is to send time synchronization requests. The reference to the remote time sync server in the MPD may be an indication in the MPD of a time sync server to be used for time synchronization requests at the time the MPD is originally received at the local HTTP server. For example, the reference to the remote time sync server may be a URI of a network time sync server or other time sync server.

FIG. 8 illustrates an example functional architecture 1001 of a personal device 106 according to an embodiment. The architecture 1001 may be similar to architectures 200 and 300 described with reference to FIGS. 2 and 3, except that the receiver architecture has not been split and entirely resides on the personal device 106. An NTP or PTP time server via HTTP, for example referred herein as a local HTTP time sync server 1002, may be included in the personal device 106. The local HTTP time sync server 1002 may exchange data with the HTTP proxy 202, transport interface, and physical layer (e.g., ATSC (e.g., ATSC 2.0, ATSC 3.0, etc.) or other broadcast format physical layer (e.g., eMBMS, DVB, etc.)). Additionally, the DASH player (or other media player) may interface with the local HTTP time sync server 1002 directly or through other various interfaces and/or layers. The local HTTP time sync server 1002 may synchronize with the local HTTP proxy 202 providing content to the DASH client and the DASH client may synchronize with the local HTTP time sync server 1002. In this manner, the local replica of the time source information generated by the local HTTP time sync server 1002 may be used to coordinate, access, and display content. This capability may enable the DASH client (or other media player) to operate without needing to send synchronization requests to a time sync server located remote from the personal device 106.

FIG. 9 illustrates a functional architecture 1003 including a personal device 106 and gateway 102 according to an embodiment. The architecture 1003 is similar to architecture 1001, except the receiver architecture has been split at or near the HTTP interface at the input to the media player. The HTTP proxy 202 may be on the gateway 102 to the personal device 106 as described above with reference to architecture 200 of FIG. 2. An NTP or PTP time server via HTTP, referred to herein as a local HTTP time sync server 1002, may be included in the gateway device 102. The local HTTP time sync server 1002 may exchange data with the HTTP proxy 202, transport interface, and physical layer (e.g., ATSC (e.g., ATSC 2.0, ATSC 3.0, etc.) or other broadcast format physical layer (e.g., eMBMS, DVB, etc.)). The local HTTP time sync server 1002 may synchronize with the local HTTP proxy 202 providing content to the DASH client, and the DASH client may synchronize with the local HTTP time sync server 1002. In this manner, the local replica of the time source information generated by the local HTTP time sync server 1002 may be used to coordinate, access, and display content and the DASH client (or other media player) may operate without needing to send synchronization requests to a time sync server located on the network side.

FIG. 10 illustrates a functional architecture 1005 of a personal device 106 and gateway 102 according to an embodiment. The architecture 1005 is similar to the architecture 1003, except that the HTTP proxy 202 is moved off the gateway 102 to the personal device 106 as described above with reference to architecture 300 of FIG. 3. An NTP or PTP time server via HTTP, referred herein as a local HTTP time sync server 1002, may be included in the personal device 106 and may exchange data with the HTTP proxy 202, transport interface, and physical layer (e.g., ATSC (e.g., ATSC 2.0, ATSC 3.0, etc.) or other broadcast format physical layer (e.g., eMBMS, DVB, etc.)). The local HTTP time sync server 1002 may synchronize with the local HTTP proxy 202 providing content to the DASH client and the DASH client may synchronize with the local HTTP time sync server 1002. In this manner, the local replica of the time source information generated by the local HTTP time sync server 1002 may be used to coordinate, access, and display content, and the DASH client (or other media player) may operate without needing to send synchronization requests to a time sync server located off the personal device 106. Additionally, the gateway 102 may include a thin gateway client with a NTP or PTP server as described above and shown in FIG. 10 as a thin gateway client with NTP or PTP server 1004.

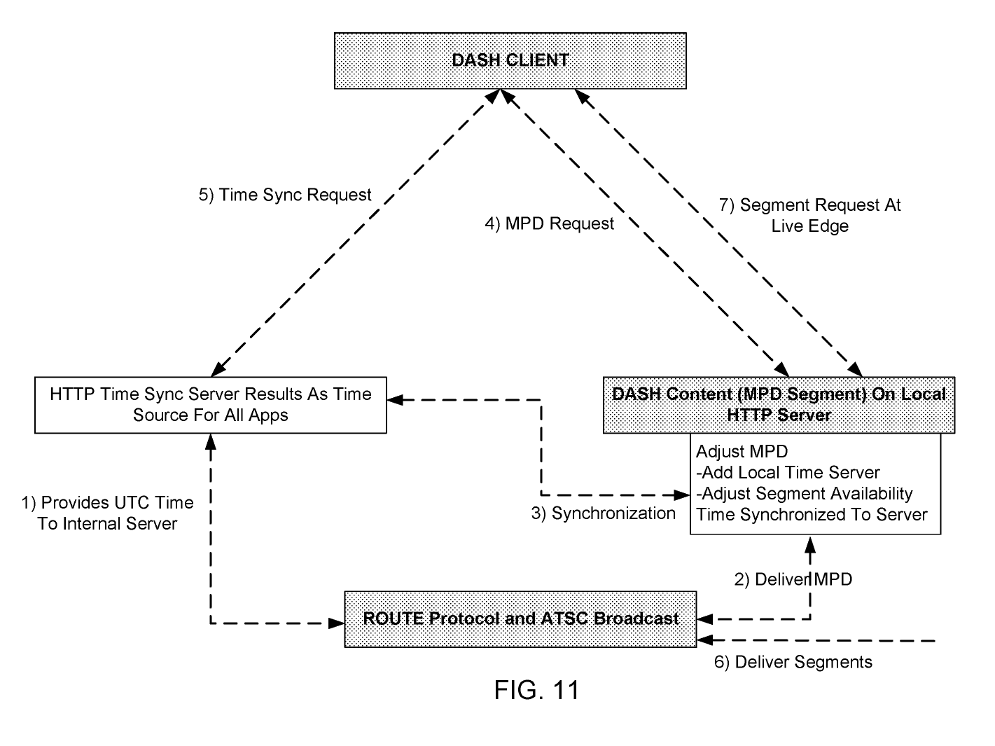

FIG. 11 is a call flow block diagram illustrating interactions between a DASH client, local HTTP time synch server, and local HTTP server according to an embodiment method for DASH client synchronization. In various embodiments, the operations illustrated in FIG. 11 may be performed by personal devices and/or gateways of architectures 1001, 1003, and/or 1005 described with reference to FIGS. 8, 9, and 10. As illustrated in FIG. 11, the ROUTE Protocol and ATSC broadcast handling layers/interfaces may provide an indication of UTC time to the local HTTP time synch server (e.g., provide time source information). Additionally, the MPD may be delivered to the HTTP proxy. The local HTTP time sync server may establish a local replica of the time source information. The HTTP proxy and local HTTP time sync server may synchronize to the same time, e.g., the local replica of the time source information. The HTTP proxy may adjust the MPD. In various embodiments, the HTTP proxy may adjust the MPD by adding a reference to a local HTTP time sync server (e.g., the URI of the local HTTP time sync server) and adjusting a segment availability timeline in the MPD to indicate times corresponding to the local HTTP time sync server time (e.g., the local replicas of the time source information). The DASH client may request the MPD from the HTTP proxy, and the HTTP proxy may provide the adjusted MPD in response. The DASH client may send a synchronization request to the local HTTP time sync server as indicated in the adjusted MPD, and thereby the DASH client may be synchronized to the same time as the HTTP proxy and local HTTP time sync server, e.g., the local replica of the time source information. The HTTP proxy may deliver segments to the DASH client as they become available. The DASH client may request the next available segment as indicated in the adjusted availability timeline of the adjusted MPD. As the time is synchronized between the HTTP proxy and DASH client via the local HTTP time sync server, the requests for segments may be at the live edge of the broadcast.

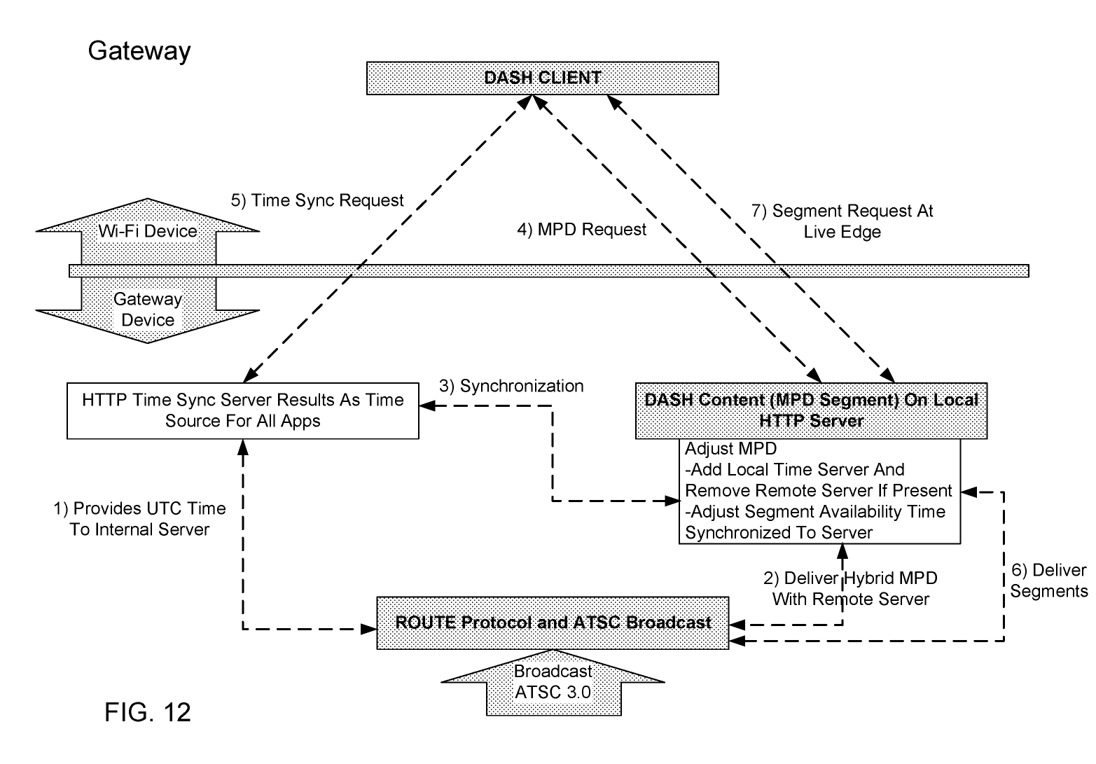

FIG. 12 is a call flow block diagram illustrating interactions between a DASH client, local HTTP time synch server, and local HTTP server according to an embodiment method for DASH client synchronization. In various embodiments, the operations illustrated in FIG. 12 may be performed by personal devices and/or gateways of architectures 1001, 1003, and/or 1005 described with reference to FIGS. 8, 9, and 10. As illustrated in FIG. 12, the ROUTE Protocol and ATSC broadcast handling layers/interfaces may provide an indication of UTC time to the local HTTP time synch server (e.g., provide time source information). Additionally, the MPD may be delivered to the HTTP proxy. The local HTTP time sync server may establish a local replica of the time source information. The HTTP proxy and local HTTP time sync server may synchronize to the same time, e.g., the local replica of the time source information.

The HTTP proxy may adjust the MPD. In various embodiments, the HTTP proxy may adjust the MPD by adding a reference to a local HTTP time sync server (e.g., the URI of the local HTTP time sync server), removing a reference to a remote time sync server, and adjusting a segment availability timeline in the MPD to indicate times corresponding to the local HTTP time sync server time (e.g., the local replicas of the time source information). The DASH client may request the MPD from the HTTP proxy, and the HTTP proxy may provide the adjusted MPD in response.

The DASH client may send a synchronization request to the local HTTP time sync server as indicated in the adjusted MPD, and thereby the DASH client may be synchronized to the same time as the HTTP proxy and local HTTP time sync server, e.g., the local replica of the time source information. The HTTP proxy may deliver segments to the DASH client as the segments become available. The DASH client may request the next available segment as indicated in the adjusted availability timeline of the adjusted MPD. As the time is synchronized between the HTTP proxy and DASH client via the local HTTP time sync server, the requests for segments may be at the live edge of the broadcast.

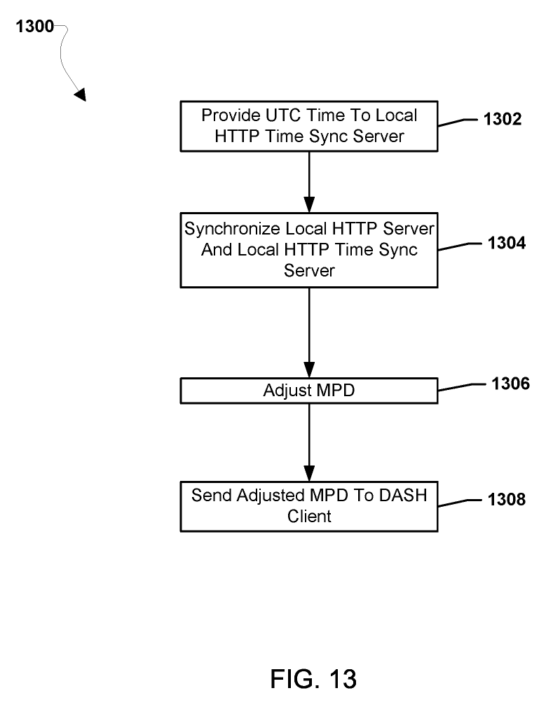

FIG. 13 illustrates an embodiment method 1300 for providing an adjusted MPD for use in DASH client synchronization. In various embodiments, the operations of the method 1300 may be performed by a processor of a gateway, such as gateway 102, and/or a processor of a personal device, such as personal device 106, in communication with the gateway 102 or not in communication with a gateway 102.

In block 1302 UTC time may be provided to a local HTTP time sync server. In various embodiments, ROUTE Protocol and ATSC broadcast handling layers/interfaces may provide the UTC time to the local HTTP time sync server.

In block 1304, the local HTTP time sync server and local HTTP proxy server may be synchronized using time information or signals from the local HTTP time sync server.

In block 1306, the MPD may be adjusted. In various embodiments, a local HTTP server may adjust an MPD, such as an MPD received from an ATSC 3.0 physical layer, by adding a reference to a local HTTP time sync server (e.g., the URI of the local HTTP time sync server) and adjusting a segment availability timeline in the MPD to indicate times corresponding to the local HTTP time sync server time. The reference to the local HTTP time sync server in the MPD may be an indication to a DASH client consuming the MPD that the local HTTP time sync server is the server to which the DASH client is to send time synchronization requests.

In various embodiments, a local HTTP server may adjust an MPD, such as an MPD received from an ATSC 3.0 physical layer, by adding a reference to the local HTTP time sync server, removing a reference to a remote time sync server in the MPD (e.g., the URI of the remote time sync server), and adjusting a segment availability timeline in the MPD to indicate times corresponding to the local HTTP time sync server time. The reference to the local HTTP time sync server in the MPD may be an indication to a DASH client consuming the MPD that the local HTTP time sync server is the server to which the DASH client is to send time synchronization requests. The reference to the remote time sync server in the MPD may be an indication in the MPD of a time sync server to be used for time synchronization requests at the time the MPD is originally received at the local HTTP server. For example, the reference to the remote time sync server may be a URI of a network time sync server or other time sync server.

While the time server depends on the physical layer to receive time in ATSC 3.0 as described above, in other protocols and embodiments the server could connect with the gateway via another data connection available within the communication architectures described herein. In some embodiments, communication links directly between the time server and the proxy type synch server executing in the gateway or personal device may result in tight time synchronization.

In block 1308, the adjusted MPD may be sent to a DASH client (or other media player). For example, the adjusted MPD may be sent to the DASH client in response to an MPD request from the DASH client.

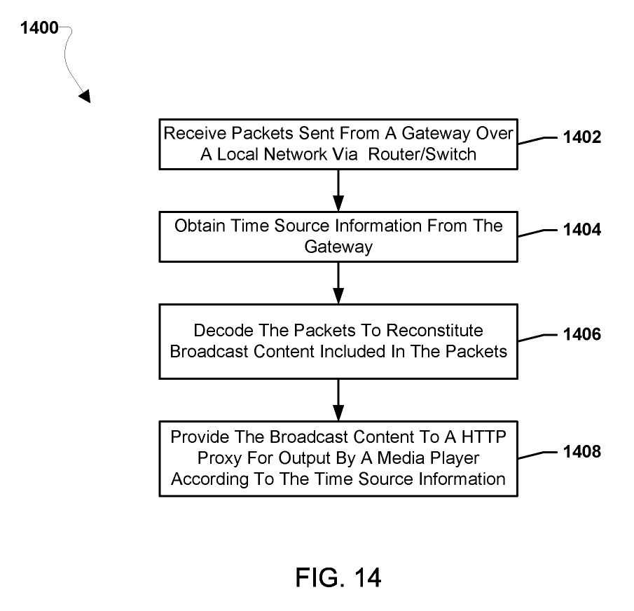

FIG. 14 illustrates an embodiment method 1400 for distribution of broadcast content. With reference to FIGS. 1-14, the operations of the method 1400 may be performed by a processor of a personal device, such as personal device 106, in communication with a gateway, such as gateway 102. In various embodiments, the operations of the method 1400 may be performed in conjunction with any one or more of the operations described with reference to FIGS. 1-13.

In block 1402, the processor may receive packets sent from a gateway over a local network via a router/switch. The packets may be any type of packets, such as UDP packets or another type of packets. In various embodiments, the packets may be received encapsulated in UDP or TCP packets.

In block 1404, the processor may obtain time source information from the gateway. In some embodiments, obtaining the time source information from the gateway may include obtaining the time source information from a local synch server executing within a processor of the gateway. In some embodiments, obtaining the time source information from the gateway may include obtaining the time source information from a preamble of the packets, such as the preamble of UDP packets. In some embodiments, time source information may be provided per station time via NTP delivery or may be provided by a broadcast network per licensed RF allocation for PTP delivery. In some embodiments, the processor may further establish a local replica of the time source information, such as a local replica of the time source information in a local synch server executing within the processor.

In block 1406, the processor may decode the packets to reconstitute broadcast content included in the packets. In some embodiments, the broadcast content may be ATSC broadcast content.

In block 1408, the processor may provide the broadcast content to a HTTP proxy for output by a media player according to the time source information. The HTTP proxy may be a HTTP proxy executing within the processor. In some embodiments, output by the media player according to the time source information may include the media player using the local replica of the time source information for coordinating access and display of the broadcast content.

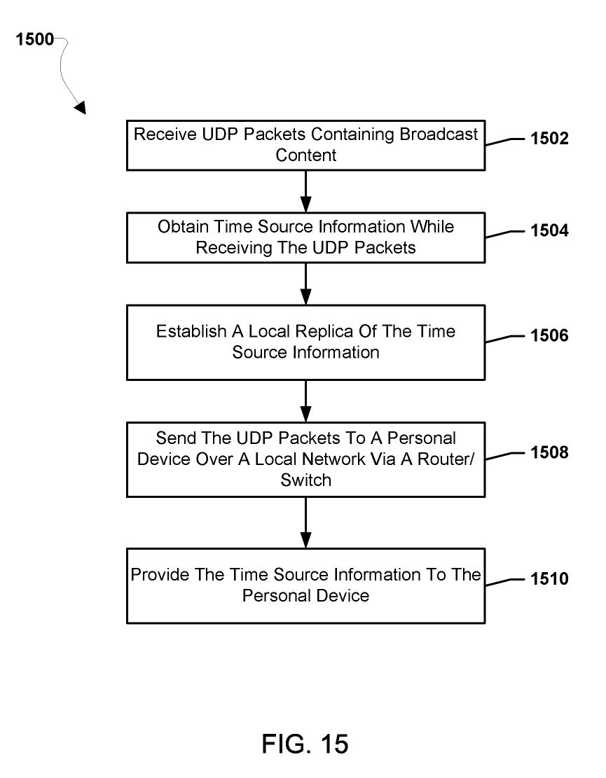

FIG. 15 illustrates an embodiment method 1500 for distribution of broadcast content from a gateway to one or more personal devices. With reference to FIGS. 1-15, the operations of the method 1500 may be performed by a processor of a gateway, such as gateway 102, in communication with a personal device, such as personal device 106. In various embodiments, the operations of the method 1500 may be performed in conjunction with any one or more of the operations described with reference to FIGS. 1-14.

In block 1502, the processor may receive UDP packets containing broadcast content. For example, the broadcast content may be ATSC broadcast content.

In block 1504, the processor may obtain time source information while receiving the UDP packets.

In block 1506, the processor may establish a local replica of the time source information. In various embodiments, time source information may be provided per station time via NTP delivery or the time source information may be provided by a broadcast network per licensed RF allocation for PTP delivery. In some embodiments, the local replica of the time source information may be established in a local synch server executing within a processor of the gateway.

In block 1508, the processor may send the UDP packets to a personal device over a local network via a router/switch. In various embodiments, the UDP packets may be sent to the personal device encapsulated in UDP or TCP packets. In various embodiments, a delivery order of the UDP packets may be preserved. In various embodiments, the UDP packets may be content is sent from the gateway on a dedicated IP connection or dedicated port number per PLP and personal device attached to the gateway.

In block 1510, the processor may provide the time source information to the personal device. In some embodiments, the time source information may be provided separate from the UDP packets to the personal device. In some embodiments, the time source information may be provided as part of the UDP packets, such as in a preamble of the UDP packets.

Various examples of different gateways, personal devices, and protocols are discussed herein, such as ATSC, DVB, eMBMS, HTTP, TCP, IP, and UDP. The discussions of specifically ATSC, DVB, eMBMS, HTTP, TCP, IP, and UDP are provided merely as examples to better illustrate the aspects of the various embodiments, and are not intended to limit the various embodiments in any way. Other gateways, personal devices, and protocols may be used with the various embodiments, and the other gateways, personal devices, and protocols may be substituted in the various examples without departing from the spirit or scope of the invention.

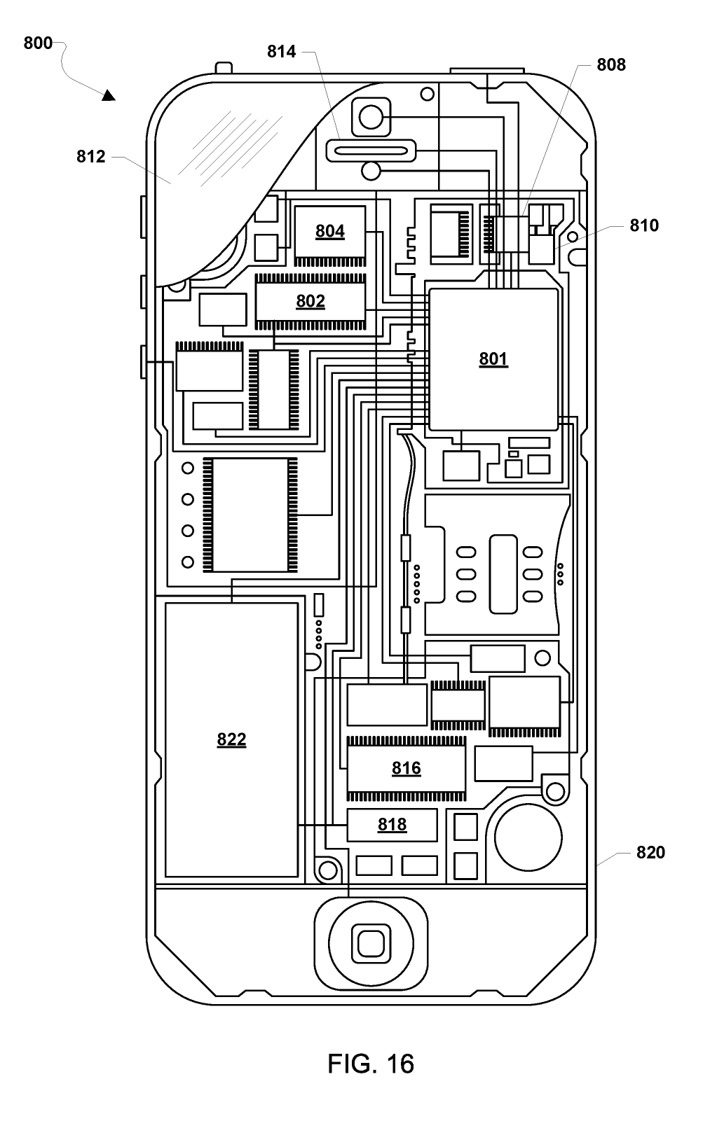

The various embodiments (including, but not limited to, embodiments discussed above with reference to FIGS. 1-15) may be implemented in any of a variety of personal devices (e.g., receiver devices), an example of which is illustrated in FIG. 16. For example, the personal device 800 may include a processor 801 coupled to a touch screen controller 804 and an internal memory 802. The processor 801 may be one or more multicore integrated circuits (ICs) designated for general or specific processing tasks. The internal memory 802 may be volatile or non-volatile memory, and may also be secure and/or encrypted memory, or unsecure and/or unencrypted memory, or any combination thereof. The touch screen controller 804 and the processor 801 may also be coupled to a touch screen panel 812, such as a resistive-sensing touch screen, capacitive-sensing touch screen, infrared sensing touch screen, etc.

The personal device 800 may have one or more radio signal transceivers 808 (e.g., Peanut®, Bluetooth®, Zigbee®, Wi-Fi, cellular, etc.) and antennae 810, for sending and receiving, coupled to each other and/or to the processor 801. The transceivers 808 and antennae 810 may be used with the above-mentioned circuitry to implement the various wireless transmission protocol stacks and interfaces. The personal device 800 may include a cellular network wireless modem chip 816 that enables communication via a cellular network and is coupled to the processor.

The personal device 800 may include a peripheral device connection interface 818 coupled to the processor 801. The peripheral device connection interface 818 may be singularly configured to accept one type of connection, or multiply configured to accept various types of physical and communication connections, common or proprietary, such as USB, FireWire, Thunderbolt, or PCIe. The peripheral device connection interface 818 may also be coupled to a similarly configured peripheral device connection port (not shown).

The personal device 800 may also include speakers 814 for providing audio outputs. The personal device 800 may also include a housing 820, constructed of a plastic, metal, or a combination of materials, for containing all or some of the components discussed herein. The personal device 800 may include a power source 822 coupled to the processor 801, such as a disposable or rechargeable battery. The rechargeable battery may also be coupled to the peripheral device connection port to receive a charging current from a source external to the personal device 800.

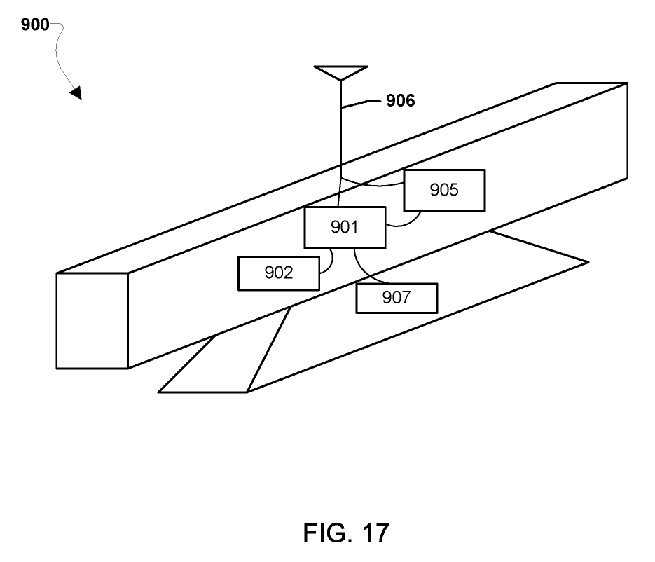

The various embodiments (including, but not limited to, embodiments discussed above with reference to FIGS. 1-15) may also be implemented on any of a variety of commercially available gateways, such as the gateway 900 illustrated in FIG. 17. Such a gateway 900 typically includes a processor 901 coupled to volatile memory 902. The gateway 900 may also include one or more antenna 906 and tuner 905 coupled to the processor 901 and configured to receive OTA broadcasts. The gateway 900 may also include one or more network transceivers 903, such as a network access port, coupled to the processor 901 for establishing wired or wireless network interface connections with a communication network 907, such as a local area network coupled to other personal devices and routers/switches, the Internet, the public switched telephone network, and/or a cellular network (e.g., CDMA, TDMA, GSM, PCS, 3G, 4G, LTE, or any other type of cellular network).

The processors 801 and 901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 801 and 901. The processors 801 and 901 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 801 and 901 including internal memory or removable memory plugged into the device and memory within the processors 801 and 901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A personal device, comprising:
a processor configured with processor-executable instructions to perform operations comprising:
receiving packets sent from a gateway over a local network via a router/switch;
obtaining time source information from the gateway;
decoding the packets to reconstitute broadcast content included in the packets; and
providing the broadcast content to a Hypertext Transfer Protocol (HTTP) proxy executing within the processor for output by a media player according to the time source information.

2. The personal device of claim 1, wherein the packets are User Datagram Protocol (UDP) packets.

3. The personal device of claim 1, wherein:
the processor is configured with processor-executable instructions to perform operations further comprising establishing a local replica of the time source information; and
the processor is configured with processor-executable instructions to perform operations such that the output by the media player according to the time source information comprises the media player using the local replica of the time source information for coordinating access and display of the broadcast content.

4. The personal device of claim 3, wherein the processor is configured with processor-executable instructions to perform operations such that establishing the local replica of the time source information in the personal device comprises establishing the local replica of the time source information in a local synch server executing within the processor.

5. The personal device of claim 1, wherein the processor is configured with processor-executable instructions to perform operations such that obtaining the time source information from the gateway comprises obtaining the time source information from a local synch server executing within a processor of the gateway.

6. The personal device of claim 1, wherein the processor is configured with processor-executable instructions to perform operations such that obtaining the time source information from the gateway comprises obtaining the time source information from a preamble of the packets.

7. The personal device of claim 1, wherein the processor is configured with processor-executable instructions to perform operations such that the time source information is provided per station time via network time protocol (NTP) delivery or the time source information is provided by a broadcast network per licensed radio frequency (RF) allocation for precision time protocol (PTP) delivery.

8. The personal device of claim 1, wherein the processor is configured with processor-executable instructions to perform operations such that the packets are received encapsulated in User Datagram Protocol (UDP) or Transmission Control Protocol (TCP) packets.

9. The personal device of claim 1, wherein the processor is configured with processor-executable instructions to perform operations such that the broadcast content is Advanced Television Systems Committee (ATSC) broadcast content.

10. The personal device of claim 9, further comprising tuning the gateway by the processor of the personal device.

11. A method for distribution of broadcast content, comprising:
receiving, by a processor of a personal device, packets sent from a gateway over a local network via a router/switch;
obtaining, by the processor, time source information from the gateway;
decoding, in the processor, the packets to reconstitute broadcast content included in the packets; and
providing, by the processor, the broadcast content to a Hypertext Transfer Protocol (HTTP) proxy executing within the processor of the personal device for output by a media player according to the time source information.

12. The method of claim 11, wherein the packets are User Datagram Protocol (UDP) packets.

13. The method of claim 11, further comprising establishing a local replica of the time source information in the personal device,
wherein the output by the media player according to the time source information comprises the media player using the local replica of the time source information for coordinating access and display of the broadcast content.

14. The method of claim 13, wherein establishing the local replica of the time source information in the personal device comprises establishing the local replica of the time source information in a local synch server executing within the processor of the personal device.

15. The method of claim 11, wherein obtaining the time source information from the gateway comprises obtaining the time source information from a local synch server executing within a processor of the gateway.

16. The method of claim 11, wherein obtaining the time source information from the gateway comprises obtaining the time source information from a preamble of the packets.

17. The method of claim 11, wherein the time source information is provided per station time via network time protocol (NTP) delivery or the time source information is provided by a broadcast network per licensed radio frequency (RF) allocation for precision time protocol (PTP) delivery.

18. A gateway, comprising:
a processor configured with processor-executable instructions to perform operations comprising:
receiving User Datagram Protocol (UDP) packets containing broadcast content;
obtaining time source information while receiving the UDP packets;
establishing a local replica of the time source information;
sending the UDP packets to a personal device over a local network via a router/switch; and
providing the time source information from to the personal device.

19. The gateway of claim 18, wherein the processor is configured with processor-executable instructions to perform operations such that the UDP packets are sent to the personal device encapsulated in UDP or Transmission Control Protocol (TCP) packets.

20. The gateway of claim 18, wherein the processor is configured with processor-executable instructions to perform operations such that establishing the local replica of the time source information in the processor of the gateway comprises establishing the local replica of the time source information in a local synch server executing within the processor of the gateway.

21. The gateway of claim 18, wherein the processor is configured with processor-executable instructions to perform operations such that the time source information is provided per station time via network time protocol (NTP) delivery or the time source information is provided by a broadcast network per licensed radio frequency (RF) allocation for precision time protocol (PTP) delivery.

22. The gateway of claim 18, wherein the processor is configured with processor-executable instructions to perform operations such that a delivery order of the UDP packets is preserved.

23. The gateway of claim 18, wherein the processor is configured with processor-executable instructions to perform operations further comprising:
determining whether the local network supports UDP transmissions within the local network; and
sending the UDP packets to the personal device over the local network via the router/switch by Transmission Control Protocol (TCP) in response to determining that the local network does not support UDP transmission within the local network.

24. The gateway of claim 18, wherein the processor is configured with processor-executable instructions to perform operations further comprising determining an IP connection address for content delivery between the gateway and each connected personal device by local network service discovery or by assignment of predefined addresses according to an order of connection.

25. The gateway of claim 18, wherein the processor is configured with processor-executable instructions to perform operations further comprising determining a port number for content delivery between the gateway and each connected personal device by assignment of predefined port numbers according to an order of connection.

26. The gateway of claim 18, wherein the processor is configured with processor-executable instructions to perform operations further comprising discovering, in-band, available UDP connections via a Transmission Control Protocol (TCP) connection between the personal device and the gateway.

27. The gateway of claim 18, wherein the processor is configured with processor-executable instructions to perform operations such that content is sent from the gateway on a dedicated IP connection or dedicated port number per Physical Layer Pipe (PLP) and personal device attached to the gateway.

28. The gateway of claim 18, further comprising:
a first tuner resource connected to the processor; and
a second tuner resource connected to the processor,
wherein the processor is configured with processor-executable instructions to perform operations such that:
a first currently connected personal device has control of the first tuner resource;
a second currently connected personal device has control of the second tuner resource; and
personal devices joining after the first tuner resource and the second tuner resource are reserved have a choice of selecting the first tuner resource or the second tuner resource without control of the first tuner resource's or the second tuner resource's tuned frequencies.

29. The gateway of claim 19, wherein the processor is configured with processor-executable instructions to perform operations such that the broadcast content is Advanced Television Systems Committee (ATSC) broadcast content.

30. A method for distribution of broadcast content from a gateway to one or more personal devices, comprising:
receiving User Datagram Protocol (UDP) packets containing broadcast content at a processor of a gateway;
obtaining, by the processor of the gateway, time source information while receiving the UDP packets;
establishing a local replica of the time source information in the processor of the gateway;
sending the UDP packets from the processor of the gateway to a personal device over a local network via a router/switch; and
providing the time source information from the processor of the gateway to the personal device.
